(19) United States
(12) Patent Application Publication
(10) Pub. No.: US 2009/0115913 A1
(43) Pub. Date: May 7, 2009

(54) Digital Television Receiving Device and a Method for Adjusting Digital Television Signals

(76) Inventors: Shou-Hsiu Hsu, Taipei City (TW); Fou-Ming Liou, Taipei City (TW); Kuo-Hsun Huang, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/211,907

(22) Filed: Sep. 17, 2008

(30) Foreign Application Priority Data
Nov. 5, 2007 (TW) 096141760

(51) Int. Cl. H04N 5/50

(52) U.S. Cl. 348/732; 348/E05.098

(57) ABSTRACT

The present invention relates to a digital television receiving device and a method for adjusting digital television signals thereof. The method comprises: receiving a GPS signal; obtaining a moving velocity of the digital television receiving device according to the GPS signal; looking up a parameter table to obtain one frequency adjusting value of the digital television signal corresponding to the moving velocity; and adjusting the frequency of the received digital television signal according to the frequency adjusting value of the moving velocity.

### BACKGROUND OF THE INVENTION

1. Field of the Invention

The present invention relates to a method for adjusting digital television signals, and more particularly, the present invention relates to a digital television receiving device and a method for adjusting digital television signals thereof.

2. Description of the Related Art

As the related technique keeps improving, more and more users require higher video quality, therefore, the digital television receiver is more popular. Currently, there are many kinds of portable digital television receiving devices in the market, and the users no longer need to stay in one place to watch digital television programs. But in a high speed moving vehicle, the digital television receiving device may not able to receive the digital television signal at the default frequency due to the Doppler Effect, and the digital television image will be stopped in the same picture. In addition, the reception of the digital television signal at some specific area may become bad due to the geography.

In the prior art, the digital television receiving device has frequency searching function for repeatedly searching the proper signal with its frequency near the default frequency. But the above method is time-consuming, and the frequency of the signal may over the frequency searching range of the digital television receiving device.

### SUMMARY OF THE INVENTION

It is therefore an object of the present invention to provide a digital television receiving device and a method for adjusting digital television signals thereof, in order to adjusting the frequency of the received digital television signals according to a GPS (Global Positioning System) signal.

To achieve the object mentioned above, the digital television receiving device of the present invention comprises a GPS signal module, a digital television signal module, a memory unit, and a processor. The GPS signal module comprises a GPS antenna for receiving a GPS signal. The digital television signal module comprises a digital television antenna for receiving a digital television signal. The memory unit stores a parameter table containing a plurality of frequency adjusting values corresponding to different moving velocities. The processor is electrically connected to the GPS signal module, the digital television signal module, and the memory unit. Wherein, after the GPS signal module receiving the GPS signal, the processor obtains a moving velocity of the digital television receiving device according to the GPS signal, and then looks up the parameter table to obtain one frequency adjusting value of the digital television signal corresponding to the moving velocity in order to adjust the frequency of the received digital television signal.

The adjusting method of the present invention comprises: receiving a GPS signal; obtaining a moving velocity, a position, or a relative position of the digital television receiving device according to the GPS signal; looking up a parameter table to obtain one frequency adjusting value of the digital television signal; and adjusting the frequency of the received digital television signal according to the frequency adjusting value.

Other objects, advantages, and novel features of the present invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a functional block diagram of a digital television receiving device of the present invention.

FIG. 2 is a parameter table of the digital television receiving device of the present invention.

FIG. 3 is a flow chart of the digital television signal adjusting method of the present invention.

### DETAILED DESCRIPTION OF THE PREFERRED EMBODIMENT

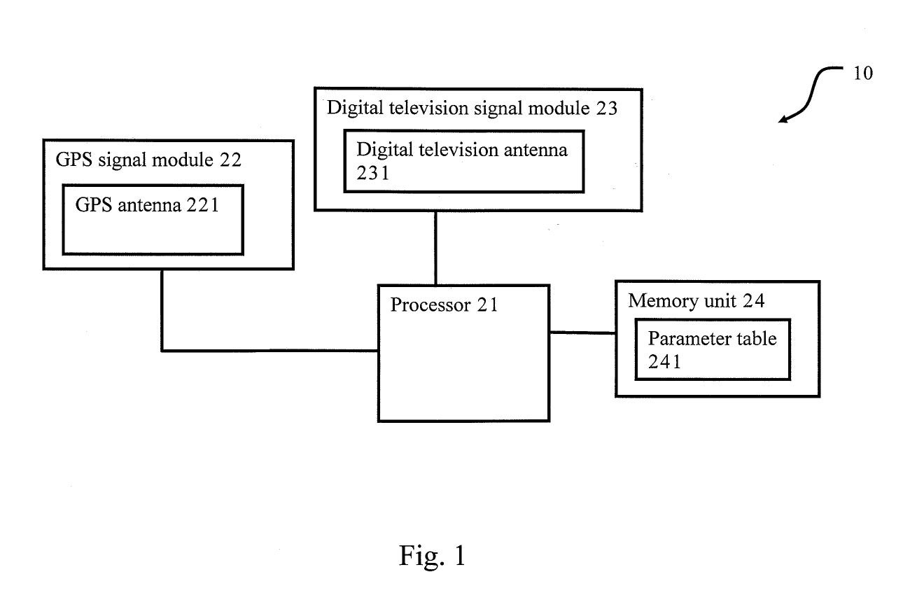

Please refer to FIG. 1. FIG. 1 is a functional block diagram of a digital television receiving device of the present invention.

As shown in FIG. 1, the digital television receiving device 10 of the present invention comprises a processor 21, a GPS signal module 22, a digital television signal module 23, and a memory unit 24. The processor 21 is electrically connected to the GPS signal module 22, the digital television signal module 23, and the memory unit 24.

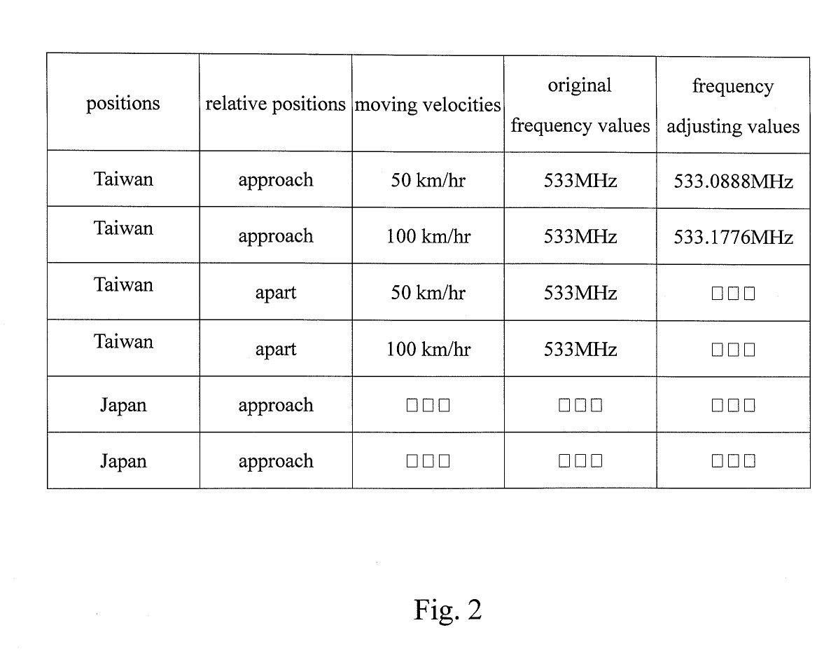

The GPS signal module 22 comprises a GPS antenna 221 for receiving GPS signals. The digital television signal module 23 comprises a digital television antenna 231 for receiving digital television signals with different frequencies. The memory unit 24 stores a parameter table 241, which contains a plurality of frequency adjusting values. For example, the different frequency adjusting values corresponding to different moving velocities stored in the parameter table 241 (as shown in FIG. 2). The processor 21 can control the GPS signal module 22, the digital television signal module 23, and the memory unit 24 to perform the method for adjusting digital television signals in order to receive digital television signals while moving (ex. in a moving vehicle).

The method for adjusting digital television signals of the present invention will be further described later.

More particularly, in one embodiment of the present invention, the GPS signal module 22, the digital television signal module 23, and the processor 21 can be installed in the same housing. Or, in other embodiments of the present invention, the GPS signal module 22, the digital television signal module 23, and the processor 21 can be installed in the different housings, but electrically connected to each other by external connectors. For example, the GPS signal module 22 and/or the digital television signal module 23 can be electrically connected to the processor 21 by an interface of RS232, USB, or SPI, but the connecting interface is not limited by the above. In addition, in one embodiment of the present invention, the memory unit 24 is a non-volatile memory unit, but not limited by the above.

Please refer to FIG. 2, and refer to FIG. 1 as well. FIG. 2 is a parameter table of the digital television receiving device of the present invention. The parameter table 241 contains original frequency values of the digital television signals, and frequency adjusting values of the digital television signals for different positions, different moving velocities, and different relative positions. Wherein, the relative position is a relative position between the digital television receiving device 10 and a digital television signal emitter (not shown). The digital television signal emitter is a transmitting device of the digital television signals, and it can be an airwave tower.

In the parameter table 241 of present embodiment, the original frequency values and the frequency adjusting values of the digital television signals are set according to the located geography, area, or country. For example, each country has its own frequencies of the digital television signals. Therefore, the parameter table 241 contains the original frequency values and the frequency adjusting values of different countries. FIG. 2 shows the original frequency values and the frequency adjusting values of Taiwan and Japan. Because the position of the digital television receiving device 10 can be obtained according to the GPS signal, the present invention can look up the parameter table 241 to obtain the original frequency values and the frequency adjusting values corresponding to different geography, area, or country, in order to adjust the digital television signals while moving (ex. in a moving vehicle).

In addition, in the parameter table 241, the original frequency values and the frequency adjusting values of different relative positions and moving velocities are obtained according to a Doppler compensation formula.

According to the Doppler Effect, the aparting wave has lower frequency, and the approaching wave has higher frequency. Therefore, when the digital television receiving device 10 is aparting from the digital television signal emitter, the Doppler compensation formula will be:

$$F = f ( \frac{V - Vu}{V} ) or F = f ( \frac{V}{V + Vu} )$$

When the digital television receiving device 10 is approaching to the digital television signal emitter, the Doppler compensation formula will be:

$$F = f ( \frac{V + Vu}{V} ) or F = f ( \frac{V}{V - Vu} )$$

Wherein, F is the adjusted frequency, f is the original frequency, V is the light speed, and Vu is the moving velocity of the digital television receiving device 10.

The above Doppler compensation formulas are well known, therefore, they are not further described.

The parameter table 241 is built according to the Doppler compensation formulas to obtain the original frequency values and the frequency adjusting values of different relative positions and moving velocities. For example, if the digital television receiving device 10 is approaching to the digital television signal emitter at a speed of 50 km/hr, the original frequency 533 MHZ of the received digital television signals should be adjusted to 533.0888 MHZ according to the Doppler compensation formulas. If the digital television receiving device 10 is approaching to the digital television signal emitter at a speed of 100 km/hr, the original frequency 533 MHZ of the received digital television signals should be adjusted to 533.1776 MHZ. Similarly, If the digital television receiving device 10 is aparting from the digital television signal emitter, the new frequency adjusting value can be obtained by substituting the related values into the Doppler compensation formulas.

More particularly, the values in the parameter table 241 are not limited by the above description and the FIG. 2. There can be more or less values in the parameter table 241 according to the requirements.

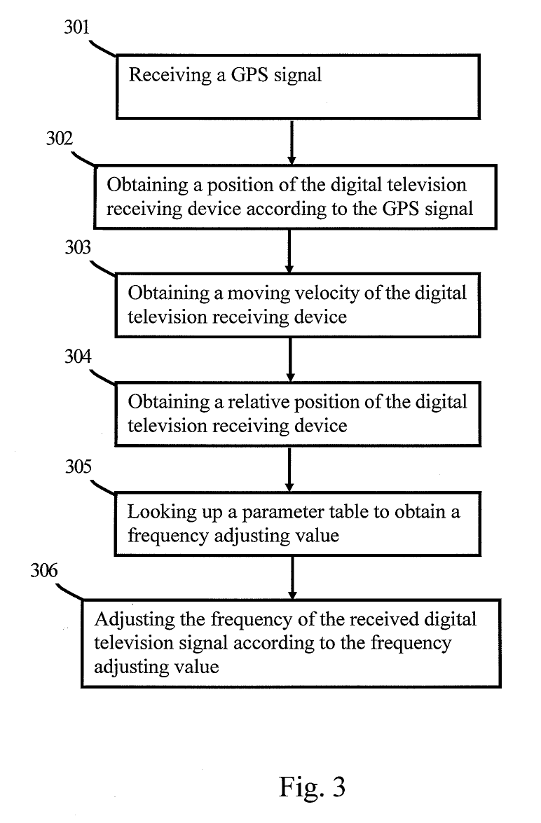

Please refer to FIG. 3, and refer to FIG. 1 as well. FIG. 3 is a flow chart of the digital television signal adjusting method of the present invention. The adjusting method of the present invention is described by the following steps, but not limited by these steps.

First, in step 301: receiving a GPS signal.

In the digital television receiving device 10, the GPS antenna 221 of the GPS signal module 22 is capable of receiving GPS signals.

In step 302: obtaining a position of the digital television receiving device 10 according to the GPS signal.

According to the GPS signal, the position of the digital television receiving device 10 can be obtained in order to determine which geography, area, or country is the digital television receiving device 10 located.

In step 303: obtaining a moving velocity of the digital television receiving device 10.

Because the GPS antenna 221 of the GPS signal module 22 can receive GPS signals continually, the moving velocity of the digital television receiving device 10 can be obtained according to the changing of the positions in a period of time.

In step 304: obtaining a relative position of the digital television receiving device 10.

Because the position and moving velocity of the digital television receiving device 10 are obtained in step 302 and step 303 respectively, therefore, the present invention can further determine whether the digital television receiving device 10 is aparting from or approaching to the digital television signal emitter.

In step 305: looking up a parameter table to obtain a frequency adjusting value.

Because the position, moving velocity, and relative position of the digital television receiving device 10 are obtained in step 302, step 303, and step 304 respectively, therefore, the present invention can look up the parameter table 241 to obtain a frequency adjusting value corresponding to the position, moving velocity, and relative position.

Finally, in step 306: adjusting the frequency of the received digital television signal according to the frequency adjusting value.

In step 306, the frequency of the digital television signal can be adjusted according to the frequency adjusting value. For example, through step 302 to step 304, if the present invention detects the digital television receiving device 10 is approaching to the digital television signal emitter at a speed of 100 km/hr in Taiwan, the processor 21 can look up the parameter table 241 to adjust the frequency of the digital television signal from 533 MHz to 533.1776 MHz. In addition, in order to achieve the best result, the processor 21 can also use a try and error method to fine tune the frequency of the digital television signal. In other words, the processor 21 can fine tune the frequency of the digital television signal around 533.1776 MHz to achieve the best result.

More particularly, to achieve the same result, the steps of the method of the present invention need not be in the exact order shown and need not be contiguous, that is, other steps can be intermediate.

Although the present invention has been explained in relation to its preferred embodiments, it is to be understood that many other possible modifications and variations can be made without departing from the spirit and scope of the invention as hereinafter claimed.

What is claimed is:

1. A digital television receiving device comprising:
a GPS (Global Positioning System) signal module for receiving a GPS signal;
a digital television signal module for receiving a digital television signal;
a memory unit for storing a parameter table, the parameter table containing a plurality of frequency adjusting values; and
a processor electrically connected to the GPS signal module, the digital television signal module, and the memory unit;
wherein, after the GPS signal module receiving the GPS signal, the processor obtains a moving velocity of the digital television receiving device according to the GPS signal, and then looks up the parameter table to obtain one frequency adjusting value of the digital television signal corresponding to the moving velocity in order to adjust the frequency of the received digital television signal.

2. The digital television receiving device as claimed in claim 1, wherein the parameter table is built according to a Doppler compensation formula.

3. The digital television receiving device as claimed in claim 1, wherein the processor is further capable of obtaining a position of the digital television receiving device according to the GPS signal, and looking up the parameter table to obtain one frequency adjusting value of the digital television signal corresponding to the position of the digital television receiving device.

4. A method for adjusting digital television signals suitable for a moving digital television receiving device, the method comprising:
receiving a GPS signal;
obtaining a moving velocity of the digital television receiving device according to the GPS signal;
looking up a parameter table with a plurality of frequency adjusting values to obtain one frequency adjusting value of the digital television signal corresponding to the moving velocity; and
adjusting the frequency of the received digital television signal according to the frequency adjusting value of the moving velocity.

5. The method as claimed in claim 4 further comprising building the parameter table according to a Doppler compensation formula.

6. The method as claimed in claim 4 further comprising using a try and error method to adjust the frequency of the received digital television signal.

7. The method as claimed in claim 4 further comprising:
obtaining a position of the digital television receiving device according to the GPS signal;
looking up the parameter table to obtain one frequency adjusting value of the digital television signal corresponding to the position; and
adjusting the frequency of the received digital television signal according to the frequency adjusting value corresponding to the position.

8. The method as claimed in claim 4 further comprising:
obtaining a relative position of the digital television receiving device according to the GPS signal, wherein the relative position is a relative position between the digital television receiving device and a digital television signal emitter;
looking up the parameter table to obtain one frequency adjusting value of the digital television signal corresponding to the relative position; and
adjusting the frequency of the received digital television signal according to the frequency adjusting value corresponding to the relative position.
